(19) United States
(12) Patent Application Publication
(10) Pub. No.: US 2026/0325381 A1
(43) Pub. Date: Oct. 22, 2026

(54) Medical Lift Harness

(71) Applicant: The Creative Fox, LLC, Overland Park, KS (US)

(72) Inventors: Parker Asay, Springfield, MO (US); Beth Gall, Overland Park, KS (US)

(21) Appl. No.: 19/464,146

(22) Filed: Jan. 29, 2026

Related U.S. Application Data
(60) Provisional application No. 63/751,998, filed on Jan. 31, 2025.

(51) Int. Cl. A61G 7/10

(52) U.S. Cl. CPC A61G 7/1051

(57) ABSTRACT

A harness for use with a medical lifting device includes first and second arm straps. Each strap has an attachment portion with a first side and a second side, and the first side includes a plurality of loops extending outwardly therefrom. Each arm strap also includes a bolster attached to the attachment portion, with the bolster having a passage extending therethrough. The harness also includes a torso strap extending through the bolster of the first arm strap and the bolster of the second arm strap. Each bolster is configured to extend under an arm of a user when the harness is worn by said user.

### CROSS REFERENCE TO RELATED APPLICATIONS

This application claims priority to U.S. Provisional Patent Application No. 63/751,998, filed Jan. 31, 2025, the disclosure of which is incorporated herein in its entirety by reference.

### FIELD OF THE DISCLOSURE

The disclosure relates generally to the field of medical lift devices. More specifically, the disclosure relates to a medical lift harness which extends around the torso and under the arms of a user.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

According to an embodiment, a harness for use with a medical lifting device includes first and second arm straps. Each strap has an attachment portion with a first side and a second side, and the first side includes a plurality of loops extending outwardly therefrom. Each arm strap also includes a bolster attached to the attachment portion, with the bolster having a passage extending therethrough. The harness also includes a torso strap extending through the bolster of the first arm strap and the bolster of the second arm strap. Each bolster is configured to extend under an arm of a user when the harness is worn by said user.

According to another embodiment, a harness for use with a medical lifting device has first and second arm straps. Each arm strap includes a plurality of loops formed therein, each loop being configured to receive a portion of a hook therethrough. The loops forming the plurality of loops are disposed at regular intervals along a length of each arm strap. Each arm strap also has a bolster having a passage extending therethrough. The harness further includes a torso strap extending through the bolster of the first arm strap and through the bolster of the second arm strap. Each bolster is configured to extend under an arm of a user when the harness is worn by said user.

In yet another embodiment, a method of securing a medical lift harness to a medical lift device includes providing a harness having first and second arm straps with each arm strap having a plurality of loops formed therein and a bolster having a passage extending therethrough, and a torso strap extending through the bolsters of each arm strap. The method further includes inserting a first arm of a user between an attachment portion of the first arm strap and the bolster of the first arm strap. The method continues by inserting a second arm of the user between an attachment portion of the second arm strap and the bolster of the second arm strap. The method continues still by securing the torso strap around the upper body of the user such that the bolster of the first arm strap is below the first arm of the user and the bolster of the second arm strap is below the second arm of the user. The method further continues by inserting a first portion of a first hook through a loop disposed on the first arm strap and inserting a first portion of a second hook through a loop disposed on the second arm strap. The method also includes securing a second portion of the first hook to the medical lift device and securing a second portion of the second hook to the medical lift device.

### BRIEF DESCRIPTION OF THE DRAWINGS

Illustrative embodiments of the present disclosure are described in detail below with reference to the attached drawing figures.

FIG. 1 is a perspective view of a Hoyer-type medical lift device having an embodiment of a harness attached thereto.

FIG. 2 is a perspective view of the harness of FIG. 1.

FIG. 3 is a top view of the harness of FIG. 2.

FIG. 4 is an enlarged perspective view of a strap section forming part of the harness of FIG. 2.

FIG. 5 is a profile view of a strap section forming part of the harness of FIG. 2.

FIG. 6 is a perspective view of a torso strap forming part of the harness of FIG. 2.

### DETAILED DESCRIPTION

Medical lift devices are generally known in the art and allow a physically-impaired user to be moved from one location to another, for example to and from a bed or a wheelchair. These lift devices often involve straps or a harness which extends around a user's legs or abdomen, allowing the user to be moved. While functionally effective, these existing solutions may be cumbersome or tedious to engage around the user, or may be complex. The present disclosure relates to a novel harness for use with a medical lift device, including but not limited to a Hoyer-type lift which engages primarily around the user's upper body and arms rather than the legs or abdomen as is typical. Compared to existing slings or harnesses, the present disclosure may be easier for both a user and a carer to put on and take off. The novel harness may be significantly less complex than existing solutions, resulting in a solution which is less expensive and/or exhaustive to produce and therefore may be more affordable to an end user.

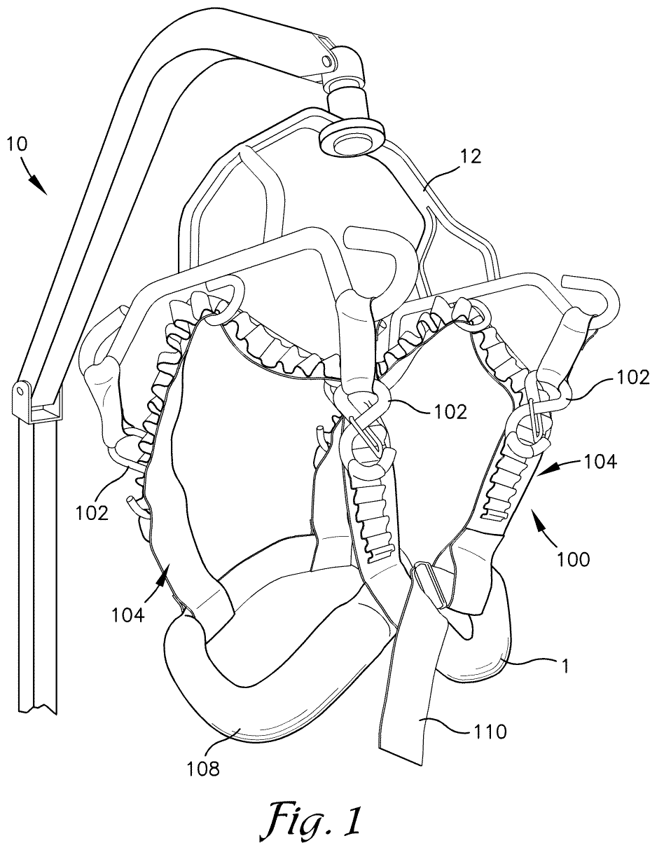

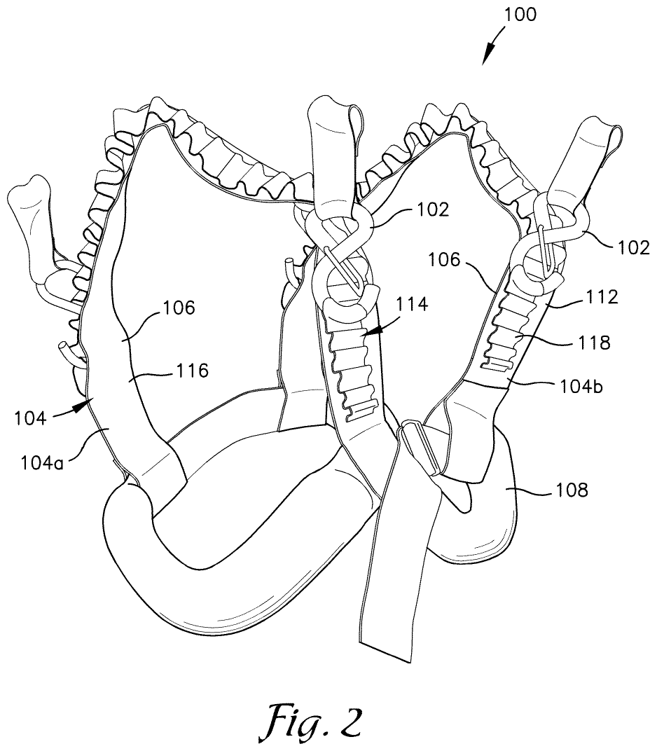

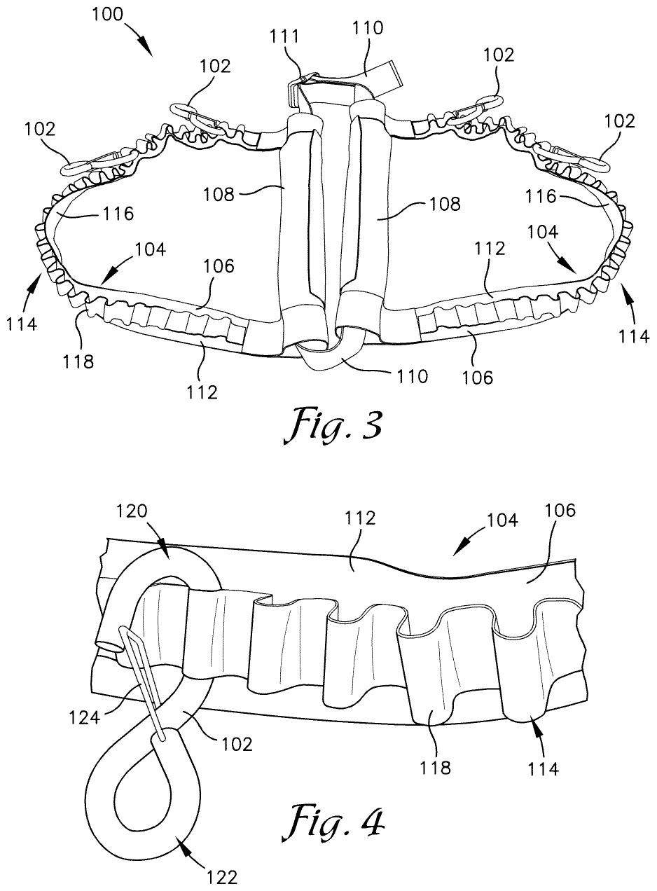

FIG. 1 shows an embodiment of a harness 100 which is attached to a medical lift device 10 by a plurality of hooks 102. The hooks 102 are secured to a bracket 12 of the lift device 10. In the embodiment shown, the configuration of the bracket 12 results in the use of four hooks 102, however one of skill in the art will appreciate that in other embodiments the bracket 12 may have a different geometry which requires a different number of hooks 102 (e.g., only two hooks 102) without departing from the scope of the disclosure. As can also be seen in FIGS. 2 and 3, the harness 100 includes left and right arm straps 104 which, when engaged, extend around the arms of a user. Each strap 104 includes an attachment portion 106, which may be substantially U-shaped, and a bolster 108 which extends from one side of the attachment portion 106 to another side, such that each strap 104 may be substantially D-shaped. When the harness 100 is worn by the user, the bolster(s) 108 extend under the arms of the user, while the attachment portion(s) 106 extend over the top of the arms of the user. The bolster 108 may be selectively detachable, for example using hook-and-loop fasteners, and may be generally annular in shape and/or have a passage extending longitudinally therethrough. The passage and/or the annular shape of the bolster 108 allows for an adjustable-length torso strap 110 to pass through each bolster 108, such that the left and right straps 104a and 104b, respectively, are connected. In some embodiments, it may be desirable for the bolsters to include an anti-slip material to prevent movement of the bolster(s) 108 when the harness is worn by the user. This includes an anti-slip or friction-generating material disposed on an exterior surface of the bolster 108 (thereby reducing slipping between the bolster 108 and the user) and/or an anti-slip or friction generating material disposed on an interior surface of the bolster 108 (thereby reducing slipping between the bolster 108 and the torso strap 110).

FIGS. 4 and 5 illustrate the attachment portion 106 of each strap 104 in greater detail. Generally, the attachment portion 106 of each strap 104 has two sides: a first side 112 containing a plurality of loops 114 extending outwardly therefrom, and a second side 116. In the illustrated embodiment, the second side 116 is generally smooth. The plurality of loops 114 are formed such that a hook 102, such as those shown in FIGS. 1-4, may be used to connect each of the arm straps 104 to the medical lift device 10. The loops are formed substantially perpendicular to the attachment portion 106 of the arm strap 104, such that when a hook 102 is inserted through a loop it is substantially perpendicular to the attachment portion 106 of the arm strap 104. In the embodiment shown, the plurality of loops 114 are formed from a singular piece of material or fabric which is attached (such as by sewing or adhesive) to the attachment portion 106 at regular intervals (i.e., periodically) to create a passageway or tube through which a hook 102 may be inserted. In other embodiments, the interval between each loop 118 of the plurality of loops 114 may be such that each loop is formed from its own discrete piece of fabric.

A skilled artisan will appreciate that the exact arrangement of loops 118 and construction of the arm straps 104a, 104b may vary from the arrangement depicted without departing from the scope of the disclosure. For example, in the illustrated embodiment, the plurality of loops 114 are generally disposed along an entire length of the attachment portion 106 of the arm straps 104. However, one of skill in the art will understand that in some embodiments each attachment portion 106 may include one or more pluralities of loops 114, with each plurality of loops 114 extending along a portion of the length of the attachment portion. For example, each attachment portion 106 may have a first plurality of loops which generally corresponds to a location of a first hook 102 for attaching to a bracket 12 of a medical lift device 10, and a second plurality of loops which generally corresponds to a location of a second hook 102 for attaching to a bracket 12 of a medical lift device 10. Alternatively, each attachment portion 106 may employ a plurality of loops disposed only at a central area of the attachment portion 106, rather than said plurality of loops extending along the entire length. In another embodiment, the plurality of loops 114 may generally resemble the illustrated embodiment, and the second, smooth side 116 of the attachment may include additional padding (e.g., foam or a similar cushioning material) disposed along at least a portion of the total length of the attachment portion 106.

The hooks 102 may be generally S-shaped and have a first end 120 and a second end 122. The first end 120 may include a member or link 124 which may be moved to open the first end 120 and allow the first end 120 to be inserted through a loop 118 of the plurality of loops 114, functionally similar to a common carabiner. The member 124 may be biased toward a closed state such that when the first end 120 is inserted into a loop 118, the first end is closed to prevent the hook 102 from sliding out of the loop. The second end 122 of the hook 102 may be closed or substantially closed and configured to engage with the bracket 12 of the medical lift 10.

Generally, the attachment portion 106 of each arm strap 104 is formed from a high-strength fabric, preferably polyester, although one of skill in the relevant art will appreciate that any suitable material now known or later developed may be used to form the attachment portion 106 of the straps 104 as shown and described herein. In some embodiments, including the preferred and illustrated embodiment, the plurality of loops 114 may be formed from the same material as the attachment portion 106, although in other embodiments the plurality of loops 114 may be formed from a different material than that of the attachment portion 106.

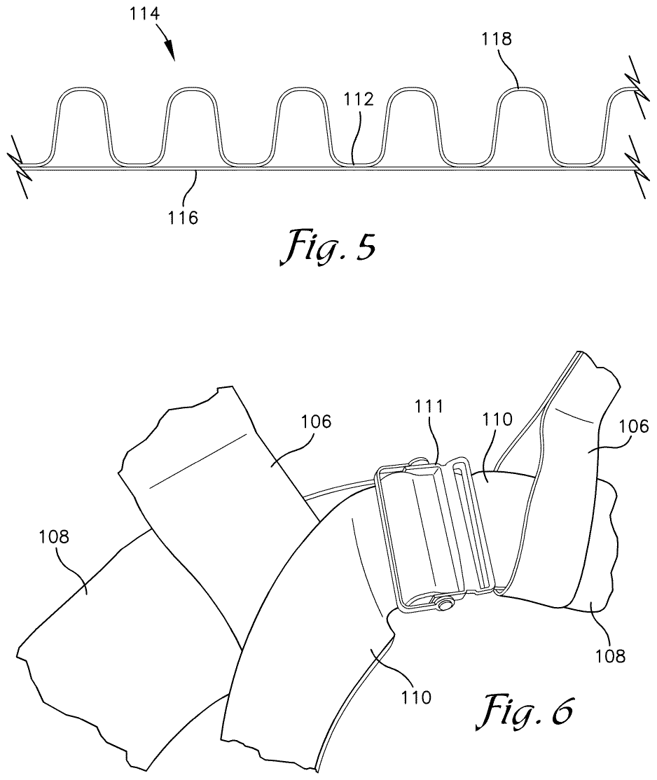

FIG. 6 illustrates the torso strap 110 in greater detail. When the harness 100 is worn by a user (generally in the orientation shown in FIGS. 1 and 2), the adjustable torso strap 110 may extend across the user's chest on one side and across the user's back on an opposite side, and the user and/or a carer may adjust the length of the torso strap 110 to fit the user as desired via an adjuster 111. One of skill in the art will appreciate in some embodiments the length of the torso strap may not be adjustable and instead the torso strap 110 may be formed from any strong and durable fabric, such as cotton blends or elastic material which allows the harness 100 to fit a variety of body types. In some embodiments, the torso strap 110 may not include an adjuster 111. Instead, the torso strap 110 may be formed from a suitably elastic material now known or later developed which allow the torso strap 110 to be stretched to allow the harness 100 to be properly secured to the user, thereby providing a compressive force against the user's chest. The torso strap 110 may be formed from the same material as the attachment portion 106 of the arm straps 104, or may be formed from a more durable fabric or elastic material as described above.

The general process for securing a user into the harness 100 and securing the harness to a medical lift device 10, such as that shown in FIG. 1, is straightforward. Starting from a completely detached state, such as that shown in FIG. 3, a user's first arm may be inserted between the attachment portion 106 of a first arm strap 104 and a first bolster 108. Then, a user's second arm may be inserted between the attachment portion 106 of the opposite arm strap 104 and the opposite bolster 108. Each bolster 108 may then be moved into position under the respective arm of the user, with the user's head and upper body being positioned between the bolsters 108. The torso strap 110 may be loosened or lengthened appropriately using adjuster 111 to facilitate this, and then may be tightened appropriately via the adjuster 111 to secure the bolsters 108 in place relative to the user's arms. With each attachment portion 106 of each strap 104 extending over an arm of the user, a first hook 102 may be inserted through a loop 118 of the plurality of loops 114 disposed the attachment portion 106 of the first arm strap 104. Said hook 102 may then be selectively coupled to the medical lift device 10 and/or bracket 12. Subsequent hooks 102 are then secured to the harness 100 and the medical lift device 10 in an identical manner. The steps for removing the harness 100 from a user and/or a medical lift device 10 are substantially identical to those listed above, performed in reverse.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A harness for use with a medical lifting device, the harness comprising:
first and second arm straps, each strap comprising:
an attachment portion having a first side and a second side, the first side comprising a plurality of loops extending outwardly therefrom; and
a bolster attached to the attachment portion, the bolster having a passage extending therethrough; and
a torso strap extending through the bolster of the first arm strap and the bolster of the second arm strap;
wherein each bolster is configured to extend under an arm of a user when the harness is worn by said user.

2. The harness of claim 1, wherein at least a portion of each bolster is selectively detachable from its respective arm strap.

3. The harness of claim 1, wherein a length of the torso strap is adjustable.

4. The harness of claim 1, wherein the torso strap is formed from a pliable fabric material.

5. The harness of claim 1, wherein the plurality of loops disposed on each strap is formed by a single piece of material periodically attached to the strap.

6. The harness of claim 1, wherein the plurality of loops disposed on each strap extends along an entire length of the attachment portion of said strap.

7. The harness of claim 1, wherein torso strap is formed from an elastic material and configured to apply a compressive force when the harness is worn by a user.

8. The harness of claim 1, further comprising:
a first hook having a first end extending through a loop disposed on the first strap and a second end configured to engage with the medical lifting device; and
a second hook having a first end extending through a loop disposed on the second strap and a second end configured to engage with the medical lifting device.

9. The harness of claim 8, further comprising:
a third hook having a first end extending through a second loop disposed on the first strap and a second end configured to engage with the medical lifting device; and
a fourth hook having a first end extending through a second loop disposed on the second strap and a second end configured to engage with the medical lifting device.

10. The harness of claim 1, wherein the second side of the attachment portion of each strap further comprises a cushioning material.

11. A harness for use with a medical lifting device, the harness comprising:
first and second arm straps, each arm strap comprising a plurality of loops formed therein, each loop being configured to receive a portion of a hook therethrough, and a bolster having a passage extending therethrough; and
a torso strap extending through the bolster of the first arm strap and through the bolster of the second arm strap;
wherein each bolster is configured to extend under an arm of a user when the harness is worn by said user; and
wherein the loops forming the plurality of loops are disposed at regular intervals along a length of each arm strap.

12. The harness of claim 11, wherein a length of the torso strap is adjustable.

13. The harness of claim 11, wherein each bolster includes an anti-slip material.

14. The harness of claim 13, wherein the anti-slip material is disposed on an exterior surface of the bolster.

15. The harness of claim 13, wherein the anti-slip material is disposed on an interior surface of the bolster.

16. The harness of claim 11, wherein the torso strap is formed from an elastic fabric.

17. The harness of claim 11, wherein each plurality of loops extends along an entire length of its respective arm strap.

18. The harness of claim 11, wherein each loop of the plurality of loops is a tube which is substantially perpendicular to the arm strap.

19. A method of securing a medical lift harness to a medical lift device, the method comprising:
providing a medical lift harness having first and second arm straps, each arm strap having a plurality of loops formed therein and a bolster having a passage extending therethrough, and a torso strap extending through the bolsters of each arm strap, to a medical lift device;
inserting a first arm of a user between an attachment portion of the first arm strap and the bolster of the first arm strap;
inserting a second arm of the user between an attachment portion of the second arm strap and the bolster of the second arm strap;
securing the torso strap around the upper body of the user such that the bolster of the first arm strap is below the first arm of the user and the bolster of the second arm strap is below the second arm of the user;
inserting a first portion of a first hook through a loop disposed on the first arm strap;
inserting a first portion of a second hook through a loop disposed on the second arm strap;
securing a second portion of the first hook to the medical lift device; and
securing a second portion of the second hook to the medical lift device.

20. The method of claim 19, further comprising:
inserting a first portion of a third hook through a second loop disposed on the first arm strap;
inserting a first portion of a fourth hook through a second loop disposed on the second arm strap;
securing a second portion of the third hook to the medical lift device; and
securing a second portion of the fourth hook to the medical lift device.
